(19) United States
(12) Patent Application Publication
(10) Pub. No.: US 2016/0142836 A1
(43) Pub. Date: May 19, 2016

(54) HEARING AID DEVICE

(71) Applicants: Gerald Joseph DuBrino, Saluda, VA (US); Thomas Chiarello, Easley, SC (US)

(72) Inventors: Gerald Joseph DuBrino, Saluda, VA (US); Thomas Chiarello, Easley, SC (US)

(21) Appl. No.: 14/547,540

(22) Filed: Nov. 19, 2014

(51) Int. Cl. H04R 25/00

(52) U.S. Cl. CPC H04R 25/602

(57) ABSTRACT

A hearing aid device may include a body having an interior housing, an attachment hole, a battery compartment and at least one microphone. An ear piece may be connected to the body through a wire. A microchip may be housed within the interior housing of the body. The microchip may connect to the at least one microphone and to the ear piece. An earring having a post may be removably attached to the body of the device. The post of the earring may operate to extend through an earlobe into and through the attachment hole of the body, removably securing the body to a back side of the earlobe.

### BACKGROUND OF THE INVENTION

The present invention relates to hearing aids and, more particularly, to a discreet hearing aid device.

Currently, hearing aid devices are bulky, worn above the ear, and are noticeable. People can be hesitant to wear hearing aids that are noticeable. Many forego the hearing aid finding that fashion may be more important than being able to hear properly.

As can be seen, there is a need for a hearing aid device that is hidden behind the earlobe with a short discreet receiver that may produce a heightened hearing in most situations.

### SUMMARY OF THE INVENTION

In one aspect of the present invention, a hearing aid device comprises: a body having an interior housing, an attachment hole, a battery compartment and at least one microphone; an ear piece connected to the body through a wire; and a microchip housed within the interior housing of the body, wherein the microchip connects to the at least one microphone and to the ear piece.

In another aspect of the present invention, a method of employing a hearing aid device comprises: placing an ear piece of the hearing aid device inside a first bend of an ear canal of an ear, wherein the hearing aid device further comprises a body having an interior housing, an attachment hole, a battery compartment, and at least one microphone, the ear piece connected to the body through a wire; and a microchip housed within the interior housing of the body, wherein the microchip connects to the at least one microphone and to the ear piece; placing an earring through an earlobe, wherein a post of the earring passes through the earlobe; and placing the post of the earring through the attachment hole of the body once the post passes through the ear lobe, removably securing the body of the hearing aid device to a back side of the earlobe.

These and other features, aspects and advantages of the present invention will become better understood with reference to the following drawings, description and claims.

### BRIEF DESCRIPTION OF THE DRAWINGS

FIG. 1 is a front perspective view of an exemplary embodiment of the present invention shown in use;

FIG. 2 is a side elevation view of an exemplary embodiment of the present invention showing a battery compartment shown open;

FIG. 3 is a front elevation view of an exemplary embodiment of the present invention showing a battery compartment shown closed;

FIG. 4 is a cross-sectional view of an exemplary embodiment of the present invention taken along line 4-4 of FIG. 1; and

FIG. 5 is an exploded view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a hearing aid device that may include a body having an interior housing, an attachment hole, a battery compartment and at least one microphone. An ear piece may be connected to the body through a wire. A microchip may be housed within the interior housing of the body. The microchip may connect to the at least one microphone and to the ear piece. An earring having a post may be removably attached to the body of the device. The post of the earring may operate to extend through an earlobe into the attachment hole of the body, removably securing the body to a back side of the earlobe.

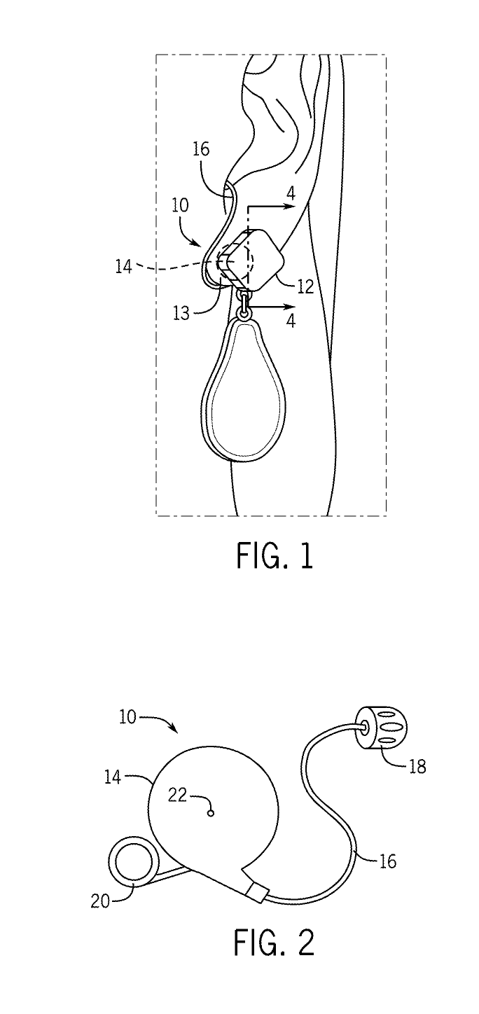

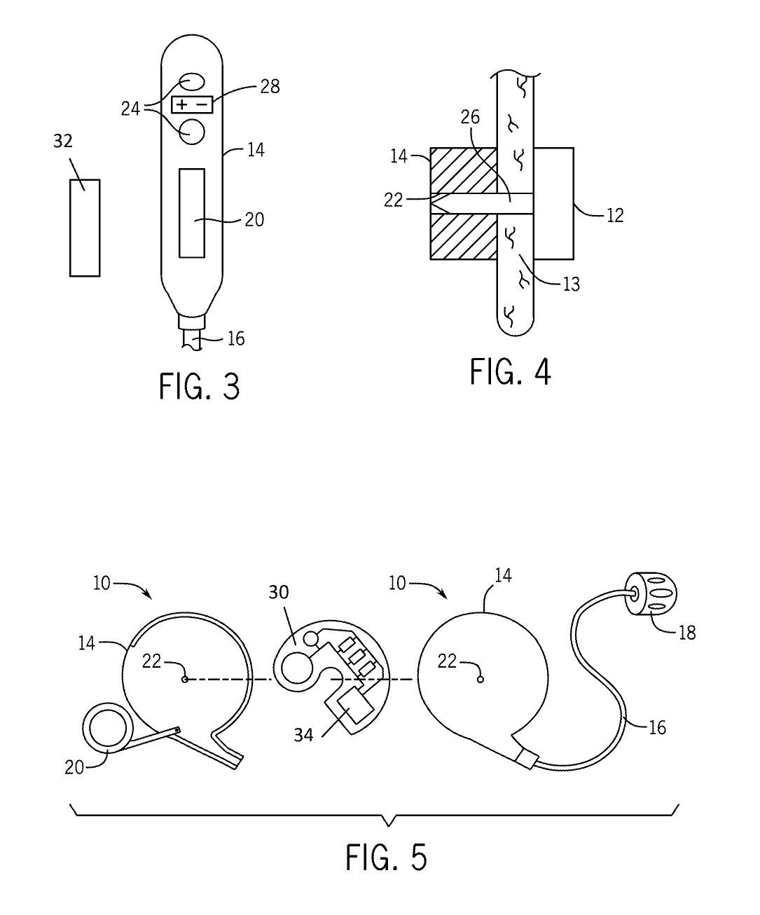

As is illustrated in FIGS. 1 through 5, a hearing aid device 10 may include a body 14 having an interior housing, an attachment hole 22, a battery compartment 20 and at least one microphone 24. An ear piece 18 may be connected to the body 14 through a wire 16. A microchip 30 may be housed within the interior housing of the body 14. The microchip 30 may connect with the at least one microphone 24 and the ear piece 18 through the wire 16. A receiver 34 may be inserted into the microchip 30. The receiver 34 may receive the speech sounds from the directional microphones 24 on the body 14 of the device 10. An earring 12 having a post 26 may removably attach to the body 14. The post 26 of the earring 12 may extend through the attachment hole 22 of the body 14. The post 26 of the earring 12 may pass through an earlobe 13 and may removably secure the body 14 to a back side of an earlobe 13 by extending through the attachment hole 22 of the body 14. In certain embodiments, an ear backing may then secure the earring 12 in place. The ear piece 18 may be a speaker. A user may place the ear piece 18 within an ear canal. The ear piece 18 may be positioned inside a first bend of the ear canal close to an eardrum further along the ear canal than a standard ear piece. The ear piece 18 may provide an increase in clarity due to the location along the ear canal. A volume control 28 may be accessed along the outside of the body 14.

The microchip 30 may detect sounds and separate background noise from speech. The background noise may be filtered and then the speech sounds may be accentuated using directional microphones 24 placed on the body 14 of the device 10. The modified signal may be placed into the ear canal through the ear piece 18 close to an eardrum for clarity while using less power than may typically be used.

In certain embodiments, the earring 12 may be of various shapes and designs. A user may be able to hear and understand people around them and participate in conversation without misunderstanding words that may make the user feel embarrassed and withdraw from activities that were once enjoyable. The present device 10 may be desirable to wear without the fear of the stigma due to hearing loss.

In certain embodiments, a remote device 32 may be used to adjust the volume. An application may be used to produce the same adjustments through a mobile device or the like.

It should be understood, of course, that the foregoing relates to exemplary embodiments of the invention and that modifications may be made without departing from the spirit and scope of the invention as set forth in the following claims.

What is claimed is:

1. A hearing aid device comprising:
a body having an interior housing, an attachment hole, a battery compartment and at least one microphone;
an ear piece connected to the body through a wire; and
a microchip housed within the interior housing of the body, wherein the microchip connects to the at least one microphone and to the ear piece.

2. The hearing aid device of claim 1, further comprising an earring having a post, wherein the post of the earring operates to extend through an earlobe and through the attachment hole of the body.

3. The hearing aid device of claim 1, wherein the ear piece comprises a speaker.

4. The hearing aid device of claim 3, further comprises a receiver inserted into the microchip, wherein the receiver operates to send a modified signal to the speaker in the ear piece.

5. The hearing aid device of claim 4, further comprising a volume control attached to the body.

6. A method of employing a hearing aid device comprising:
placing an ear piece of the hearing aid device inside a first bend of an ear canal of an ear, wherein the hearing aid device further comprises a body having an interior housing, an attachment hole, a battery compartment, and at least one microphone, the ear piece connected to the body through a wire; and a microchip housed within the interior housing of the body, wherein the microchip connects to the at least one microphone and to the ear piece;
placing a post of an earring through an earlobe; and
placing the post of the earring through the attachment hole of the body removably securing the body of the hearing aid device to a back side of the earlobe.

7. The method of claim 6, further comprising adjusting a volume level of the device through a remote device.
